(19) United States
(12) Patent Application Publication
(10) Pub. No.: US 2025/0054215 A1
(43) Pub. Date: Feb. 13, 2025

(54) RECORDING MEDIUM RECORDING PROGRAM, CONTENT EDITING METHOD, AND INFORMATION PROCESSING DEVICE

(71) Applicant: SEIKO EPSON CORPORATION, Tokyo (JP)

(72) Inventors: Kazuyoshi KITABAYASHI, AZUMINO-SHI (JP); Saki TAKEUCHI, AZUMINO-SHI (JP)

(21) Appl. No.: 18/797,621

(22) Filed: Aug. 8, 2024

(30) Foreign Application Priority Data
Aug. 8, 2023 (JP) 2023-129310

(51) Int. Cl. G06T 11/60; G06T 3/40; G06T 5/50; G06V 10/46

(52) U.S. Cl. CPC G06T 11/60; G06T 3/40; G06T 5/50; G06V 10/46; G06T 2207/20221

(57) ABSTRACT

There is provided a recording medium recording a program, the program causing a computer to execute displaying, based on a captured image obtained by capturing an image of a first object, a first image in which a contour of the first object is indicated by a line, displaying an editing image in which a content image indicating content is superimposed on at least a part of the first image, receiving input for changing the at least one of a position, a shape, and a size of the content image in the editing image, and changing at least one of the position, the shape, and the size of the content image based on the input for changing.

The present application is based on, and claims priority from JP Application Serial Number 2023-129310, filed Aug. 8, 2023, the disclosure of which is hereby incorporated by reference herein in its entirety.

### BACKGROUND

### 1. Technical Field

The present disclosure relates to a recording medium recording a program, a content editing method, and an information processing device.

### 2. Related Art

In projection mapping for projecting an image onto a projection target object, which is a stereoscopic object, using equipment such as a projector, in general, it is necessary to adjust the position, the shape, and the size of the image to match the position, the shape, and the size of the projection target object.

For example, JP-A-2021-158625 describes that a captured image is generated by capturing an image of at least a part of a projection image projected by a projector onto a projection target object and at least one of the position and the size of the projection image in the captured image is set. Here, a guide image for prompting execution of operation for the setting is displayed on a display device to be superimposed on the captured image.

JP-A-2021-158625 is an example of the related art.

In the technique described in JP-A-2021-158625, since it is difficult to visually recognize the contour of the projection target object in the captured image displayed on the display device, it is sometimes difficult to set the projection image to a position and a size intended by a user.

### SUMMARY

According to an aspect of the present disclosure, there is provided a recording medium recording a program, the program causing a computer to execute: displaying, based on a captured image obtained by capturing an image of a first object, a first image in which a contour of the first object is indicated by a line; displaying an editing image in which a content image indicating content is superimposed on at least a part of the first image; receiving input for changing at least one of a position, a shape, and a size of the content image in the editing image; and changing at least one of the position, the shape, and the size of the content image based on the input for changing.

According to another aspect of the present disclosure, there is provided a recording medium recording a program, the program causing a computer to execute: displaying, based on a captured image obtained by capturing an image of a first object, a first image in which a contour of the first object is indicated by differentiating colors of an inside and an outside of the contour from each other; displaying an editing image in which a content image indicating content is superimposed on at least a part of the first image; receiving input for changing at least one of a position, a shape, and a size of the content image in the editing image; and changing at least one of the position, the shape, and the size of the content image based on the input for changing.

According to an aspect of the present disclosure, there is provided a content editing method including: displaying, based on a captured image obtained by capturing an image of a first object, a first image in which a contour of the first object is indicated by a line; displaying an editing image in which a content image indicating content is superimposed on at least a part of the first image; receiving input for changing at least one of a position, a shape, and a size of the content image in the editing image; and displaying at least one of the position, the shape, and the size of the content image in a state in which at least one of the position, the shape, and the size of the content image is changed based on the input for changing.

According to an aspect of the present disclosure, there is provided an information processing device including: an input device; a display device; and a processing device, the processing device executing: causing the display device to display, based on a captured image obtained by capturing an image of a first object, a first image in which a contour of the first object is indicated by a line; causing the display device to display an editing image in which a content image indicating content is superimposed on at least a part of the first image; receiving, via the input device, input for changing at least one of a position, a shape, and a size of the content image in the editing image; and changing at least one of the position, the shape, and the size of the content image based on the input for changing.

### BRIEF DESCRIPTION OF THE DRAWINGS

FIG. 1 is a diagram illustrating an overview of

a system used for a content editing method according to a first embodiment.

FIG. 2 is a block diagram of an information processing device according to the first embodiment.

FIG. 3 is a flowchart illustrating a flow of the content editing method according to the first embodiment.

FIG. 4 is a diagram illustrating a display example for receiving acquisition of a captured image.

FIG. 5 is a view illustrating a display example of a first image.

FIG. 6 is a diagram illustrating a display example of an editing image.

FIG. 7 is a diagram illustrating a display example of a first display mode of an edited content image.

FIG. 8 is a diagram illustrating a display example of a second display mode of the edited content image.

FIG. 9 is a diagram illustrating projection performed using the edited content image.

FIG. 10 is a diagram illustrating a display example of an editing image in a second embodiment.

FIG. 11 is a diagram illustrating a display example of an edited content image in the case in which a first image is selected.

FIG. 12 is a diagram illustrating a display example of an edited content image in the case in which a second image is selected.

FIG. 13 is a diagram illustrating another display example of the first image.

### DESCRIPTION OF EMBODIMENTS

Preferred embodiments according to the disclosure are explained below with reference to the accompanying drawings. Note that, in the drawings, the dimensions and the scales of units are different from actual ones as appropriate. Some portions are schematically illustrated in order to facilitate understanding. The scope of the present disclosure is not limited to these embodiments unless particularly described to limit the present disclosure in the following explanation.

### 1. FIRST EMBODIMENT

### 1-1. Overview of a System Used for a Content Editing Method

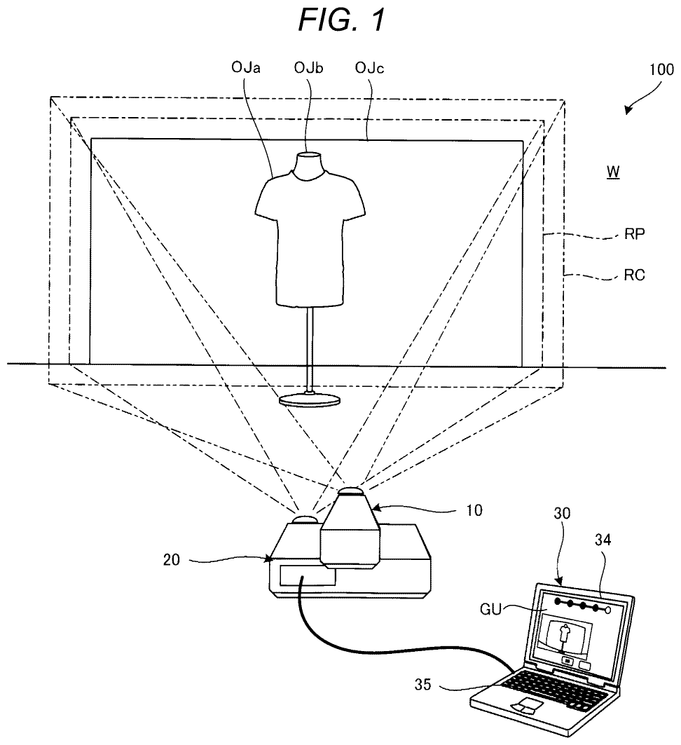

FIG. 1 is a diagram illustrating an overview of a system 100 used for a content editing method according to a first embodiment. The system 100 is a projection mapping system that projects an image to match the shape and the like of an object OJa that is a projection target object. The object OJa is an example of a “first object”.

In the example illustrated in FIG. 1, the object OJa is a plain T shirt of white or the like in a state of being worn on an object OJb. The object OJb is, for example, a torso or a mannequin. The shape, the size, the position, and the like of each of the objects OJa and OJb are not limited to the example illustrated in FIG. 1 and are optional. The object OJa only has to be a projection target object of projection mapping and is not limited to the T-shirt and is optional. The object OJb is not limited to the torso or the mannequin and may be used according to necessity or may be omitted.

As illustrated in FIG. 1, the system 100 includes a camera 10, a projector 20, and an information processing device 30. The units of the system 100 are briefly explained below with reference to FIG. 1.

The camera 10 is a digital camera including a capturing element such as a CCD (Charge Coupled Device) or a CMOS (Complementary Metal Oxide Semiconductor). The camera 10 generates captured image data DGa explained below indicating a captured image Ga explained below obtained by capturing an image of the objects OJa and OJb. Here, the objects OJa and OJb are present in an image capturing region RC that is a region where image capturing by the camera 10 is possible.

In the example illustrated in FIG. 1, the image capturing region RC includes an object OJc besides the objects OJa and OJb. The object OJc is a screen installed along a wall surface W located behind the objects OJa and OJb when viewed from the camera 10 and the projector 20. The object OJc is used according to necessity or may be omitted. An installation position and an installation posture of the camera 10 are not limited to the example illustrated in FIG. 1 and are optional. Further, the camera 10 may be a part of the information processing device 30.

The projector 20 is a display device that projects an image onto the object OJa under the control by the information processing device 30. Here, the projection region RP, which is a region where projection by the projector 20 is possible, includes the objects OJa, OJb, and OJc.

In the example illustrated in FIG. 1, the projection region RP is included in the image capturing region RC. The projection region RP only has to include the objects OJa and OJb and may include a portion not included in the image capturing region RC. An installation position and an installation posture of the projector 20 are not limited to the example illustrated in FIG. 1 and are optional.

Although not illustrated, the projector 20 includes an image processing circuit, a light source, a light modulation device, and a projection optical system. The image processing circuit of the projector 20 is a circuit that controls driving of the light modulation device of the projector 20 based on information from the information processing device 30. The light source of the projector 20 includes, for example, halogen lamps, xenon lamps, ultra-high pressure mercury lamps, LEDS (Light Emitting Diodes), or laser light sources, which respectively emit red light, green light, and blue light. The light modulation device of the projector 20 includes three light modulation elements provided to correspond to red, green, and blue. Each of the three light modulation elements is a display panel such as a transmissive liquid crystal panel, a reflective liquid crystal panel, or a DMD (digital mirror device). The three light modulation elements respectively modulate red, green, and blue lights based on a signal from the image processing circuit of the projector 20 to generate image lights of the colors. The image lights of the colors are combined by a color combination optical system to be full color image light. The projection optical system of the projector 20 is an optical system including a projection lens and projects the full color image light explained above onto a projection target object to form an image thereon.

The information processing device 30 is a computer that executes a content editing method explained in detail below and has a function of acquiring a captured image from the camera 10, a function of editing an image used for projection by the projector 20 using the captured image, and a function of controlling an operation of the projector 20.

In the example illustrated in FIG. 1, the information processing device 30 is a laptop computer. The information processing device 30 is not limited to the laptop computer and may be, for example, a desktop computer, a smartphone, or a tablet terminal. When the information processing device 30 has a capturing function, the information processing device 30 may also serve as the camera 10.

As explained in detail below, the information processing device 30 includes a display device 34 and an input device 35 and causes the display device 34 to display a user interface image GU, which is a GUI (graphical user interface) image necessary for executing the content editing method. In the drawings, “user interface” is sometimes described as “UI”. Then, the information processing device 30 executes, based on an instruction from a user via the input device 35, editing of an image used for projection by the projector 20. The user interface image GU is capable of receiving, from the user, editing operation for matching the shape of an image projected from the projector 20 onto a projection target object with the shape of the projection target object. Here, the user interface image GU includes a line drawing Gb explained below that indicates the contour of the projection target object with a line based on a captured image Ga explained below acquired from the camera 10 to make it easy to match the shape of the image projected onto the projection target object from the projector 20 with the shape of the projection target object.

### 1-2. Information Processing Device

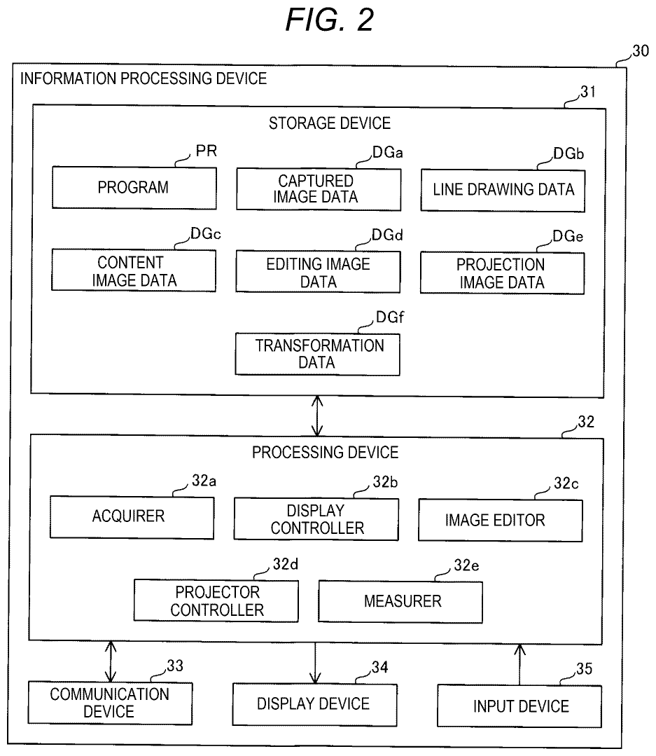

FIG. 2 is a block diagram of the information processing device 30 according to the first embodiment. As illustrated in FIG. 2, the information processing device 30 includes a storage device 31, a processing device 32, a communication device 33, a display device 34, and an input device 35. These devices are communicably connected to one another.

The storage device 31 is a storage device that stores programs such as an operating system and application programs to be executed by the processing device 32 and data to be processed by the processing device 32. The storage device 31 includes, for example, a hard disk drive or a semiconductor memory. A part or the entire storage device 31 may be an external storage device of the information processing device 30 or may be provided in an external device such as a server connected to the information processing device 30 via a communication network such as the Internet.

The storage device 31 stores a program PR, captured image data DGa, line drawing data DGb, content image data DGc, editing image data DGd, projection image data DGe, and transformation data DGf.

The program PR is a program for executing a content editing method explained in detail below. The captured image data DGa is data indicating a captured image acquired from the camera 10. The captured image data DGa may be a captured image obtained at the time of measurement in a measurer 32e explained below or may be a captured image separate from the captured image obtained at the time of the measurement in the measurer 32e explained below. The line drawing data DGb is data in which the captured image indicated by the captured image data DGa is expressed by a line drawing. The content image data DGc is data indicating a content image Gc indicating content. The content image is an image illustrating a photograph, a pattern, a color, a combination thereof, or the like as content. The content image may be a moving image or a still image. The content image data DGc only has to include at least one piece of data indicating the content image Gc. In the present embodiment, the content image data DGc includes a plurality of data files indicating the content image Gc. A method of acquiring a data file indicating a content image is optional. For example, at least one of the data files may be stored in the information processing device 30 in advance or may be acquired from the outside of the information processing device 30. The editing image data DGd is data indicating an image in which the content image Gc indicated by the content image data DGc is superimposed on the line drawing indicated by the line drawing data DGb. The projection image data DGe is data indicating an image projected onto the object OJa by the projector 20. The transformation data DGf is data indicating a transformation matrix for performing projective transformation between a coordinate system of a captured image of the camera 10 and a coordinate system of the display panel of the projector 20.

The processing device 32 is a processing device having a function of controlling the units of the information processing device 30 and a function of processing various data. The processing device 32 includes a processor such as a CPU (Central Processing Unit). The processing device 32 may be configured by a single processor or may be configured by a plurality of processors. A part or all of the functions of the processing device 32 may be implemented by hardware such as a DSP (Digital Signal Processor), an ASIC (Application Specific Integrated Circuit), a PLD (Programmable Logic Device), or an FPGA (Field Programmable Gate Array).

The communication device 33 is a communication device capable of communicating with the projector 20 and the like. For example, the communication device 33 is a wired communication device such as a wired LAN (Local Area Network), a USB (Universal Serial Bus), or a HDMI (High Definition Multimedia Interface) or a wireless communication device such as a LPWA (Low Power Wide Area), a wireless LAN including Wi-Fi, or Bluetooth. Each of “HDMI”, “Wi-Fi”, and “Bluetooth” is a registered trademark. The communication device 33 may be capable of communicating with the camera 10 or may be capable of communicating with a device such as an external server.

The display device 34 displays various images under the control by the processing device 32. The display device 34 is a display device including various display panels such as a liquid crystal display panel and an organic EL (electro-luminescence) display panel.

The input device 35 is input equipment that receives operation from the user. For example, the input device 35 includes a pointing device such as a touch pad, a touch panel, or a mouse. When the input device 35 includes the touch panel, the input device 35 may also serve as the display device 34.

In the information processing device 30 explained above, the processing device 32 implements various functions by referring to the various data explained above stored in the storage device 31 and executing the program PR stored in the storage device 31. Specifically, the processing device 32 executes the program PR to thereby function as an acquirer 32a, a display controller 32b, an image editor 32c, a projector controller 32d, and a measurer 32e. The processing device 32 includes the acquirer 32a, the display controller 32b, the image editor 32c, the projector controller 32d, and the measurer 32e.

The acquirer 32a acquires various information from various kinds of equipment coupled to the information processing device 30 by controlling the operation of the communication device 33 and causes the storage device 31 to store the acquired information. For example, the acquirer 32a acquires the captured image data DGa from the camera 10 and acquires the content image data DGc from a not-illustrated server or the like.

The display controller 32b controls the operation of the display device 34 to thereby cause the display device 34 to display various information. Specifically, the display controller 32b causes the display device 34 to display the user interface image GU necessary for executing the content editing method explained below. Here, the display controller 32b causes the display device 34 to display the line drawing indicated by the line drawing data DGb and causes the display device 34 to display an editing image indicated by the editing image data DGd.

The image editor 32c executes various kinds of processing necessary for executing the content editing method explained in detail below. Specifically, the image editor 32c generates the line drawing data DGb based on the captured image data DGa, generates the editing image data DGd based on the line drawing data DGb and the content image data DGc, and edits a content image indicated by the editing image data DGd based on an input result from the user. Here, the line drawing data DGb is generated, for example, by processing the captured image indicated by the captured image data DGa using a publicly-known line drawing generation technique. Therefore, the object OJa, the object OJb, and the object OJc only have to be objects whose boundaries are detectable from the captured image Ga. That is, the object OJa, the object OJb, and the object OJc are not limited to objects independent of one another and at least a part thereof may be continuous or may be flat. The editing image data DGd is generated, for example, by combining the line drawing data DGb and the content image data DGc. The content image Gc indicated by the editing image data DGd is edited, for example, by editing the content image data DGc based on the input result from the user and thereafter combining the line drawing data DGb and the content image data DGC. In this specification, generating data concerning an image is sometimes referred to as “generating an image”.

The image editor 32c generates, based on the edited content image data DGc, the projection image data DGe by transformation using the transformation data DGf. The generation of the projection image data DGe may be performed by the projector controller 32d.

The measurer 32e generates the transformation data DGf by measuring a projection surface of the projector 20 using the camera 10 and the projector 20. Specifically, the measurer 32e acquires a plurality of captured images by causing the projector 20 to sequentially project a plurality of measurement patterns onto the projection target object and causing the camera 10 to capture images of the projected measurement patterns. Based on the plurality of captured images, the measurer 32e associates coordinates of the measurement patterns in coordinate systems of the captured images of the camera 10 and coordinates of the measurement patterns in a coordinate system of the display panel of the projector 20 to thereby generate a transformation matrix for performing projective transformation of the coordinate systems. Accordingly, the transformation data DGf is obtained.

The projector controller 32d causes the projector 20 to display various information by controlling the operation of the projector 20. Specifically, the projector controller 32d causes the projector 20 to project the image indicated by the projection image data DGe.

### 1-3. Content Editing Method

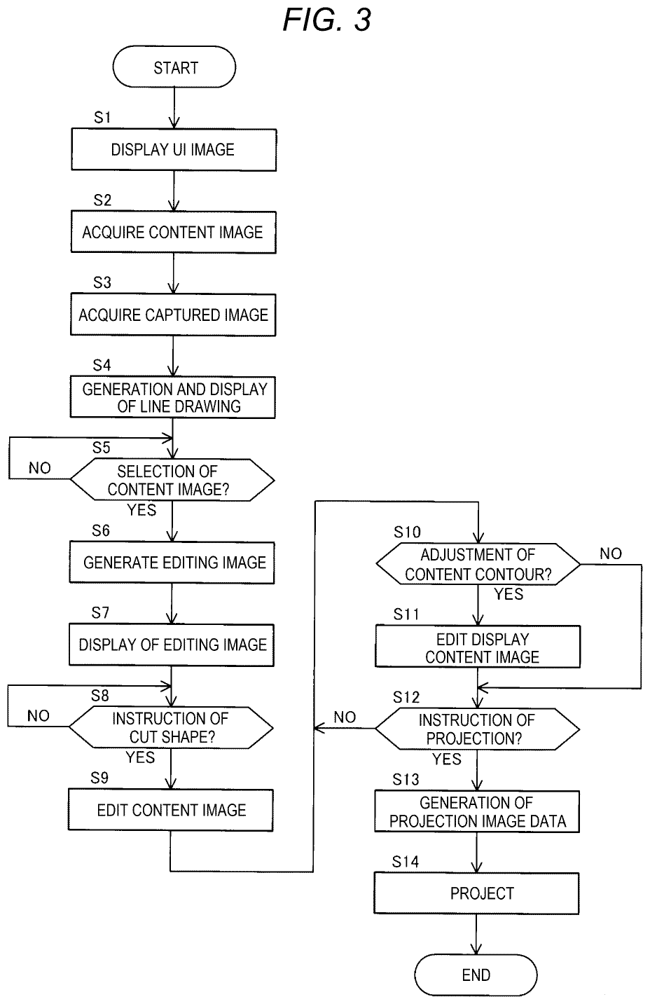

FIG. 3 is a flowchart illustrating a flow of a content editing method according to the first embodiment. The content editing method is executed by the information processing device 30 explained above.

Specifically, as illustrated in FIG. 3, first, in step S1, when the program PR is started, the display controller 32b causes the display device 34 to display the user interface image GU.

Next, in step S2, the acquirer 32a acquires the content image data DGc from a not-illustrated server or the like by controlling the operation of the communication device 33. The execution of step S2 only has to be before step S5 and may be after step S3. When the content image data DGc already stored in the storage device 31 is used, step S2 may be omitted.

Subsequently, in step S3, the acquirer 32a acquires the captured image data DGa from the camera 10 by controlling the operation of the communication device 33. In step S3, the measurer 32e generates the transformation data DGf.

Subsequently, in step S4, the image editor 32c generates the line drawing data DGb based on the captured image data DGa. In step S4, the display controller 32b causes the display device 34 to display an image indicated by the line drawing data DGb.

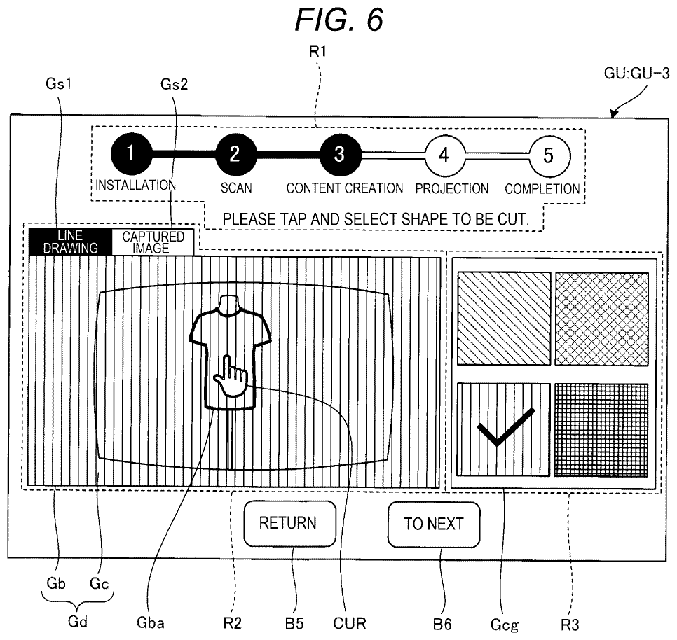

Subsequently, in step S5, the image editor 32c determines whether a content image has been selected. This determination is executed until a content image is selected (step S5: NO). Here, the selection of the content image is performed using the user interface image GU as explained below with reference to FIG. 6.

When a content image has been selected (step S5: YES), in step S6, the image editor 32c generates the editing image data DGd based on data indicating the selected content image and the line drawing data DGb.

Thereafter, in step S7, the display controller 32b controls the operation of the display device 34 to thereby cause the display device 34 to display an editing image indicated by the editing image data DGd. This display is performed in the user interface image GU.

Subsequently, in step S8, the image editor 32c determines whether a cut shape for the content image has been instructed. This determination is executed until a cut shape for the content image is instructed (step S8: NO). Here, the instruction of a cut shape is performed using the user interface image GU as explained below with reference to FIG. 6.

When a cut shape for the content image has been instructed (step S8: YES), in step S9, the image editor 32c edits, according to at least one of a position, a shape, and a size based on the instruction, the content image displayed on the display device 34.

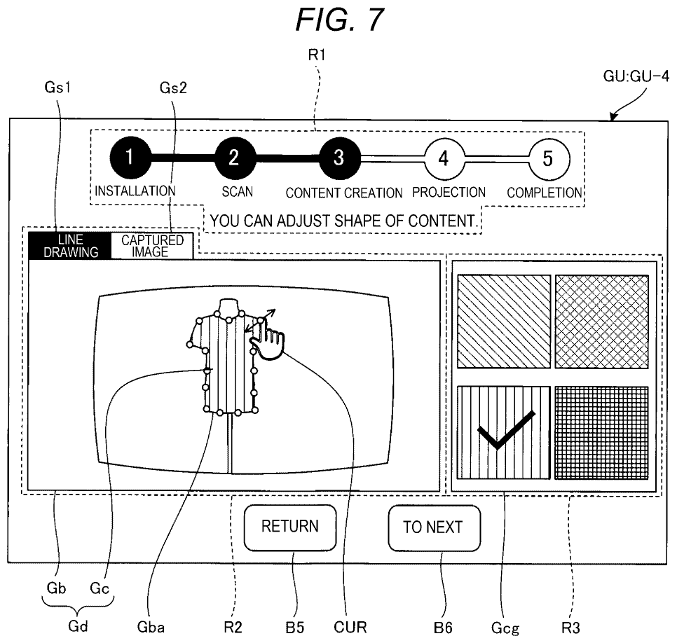

Subsequently, in step S10, the image editor 32c determines whether a contour shape of the content image has been adjusted. This adjustment is performed using the user interface image GU as explained below with reference to FIG. 7.

When a contour shape of the content image has been adjusted (step S10: YES), in step S11, the image editor 32c edits, according to the adjustment, a contour shape of the content image displayed on the display device 34.

Thereafter, when a contour shape of the content image has not been adjusted (step S10: NO), in step S12, the image editor 32c determines whether projection by the projector 20 has been instructed. When projection by the projector 20 has not been instructed (step S12: NO), the image editor 32c returns to step S10 explained above.

When projection by the projector 20 has been instructed (step S12: YES), in step S13, the image editor 32c generates the projection image data DGe based on information concerning the position, the shape, and the size of the edited content image. Here, the projection image data DGe is generated, based on the edited content image data DGc, by transformation using the transformation data DGf.

Thereafter, in step S14, the projector controller 32d causes the projector 20 to project an image based on the projection image data DGe.

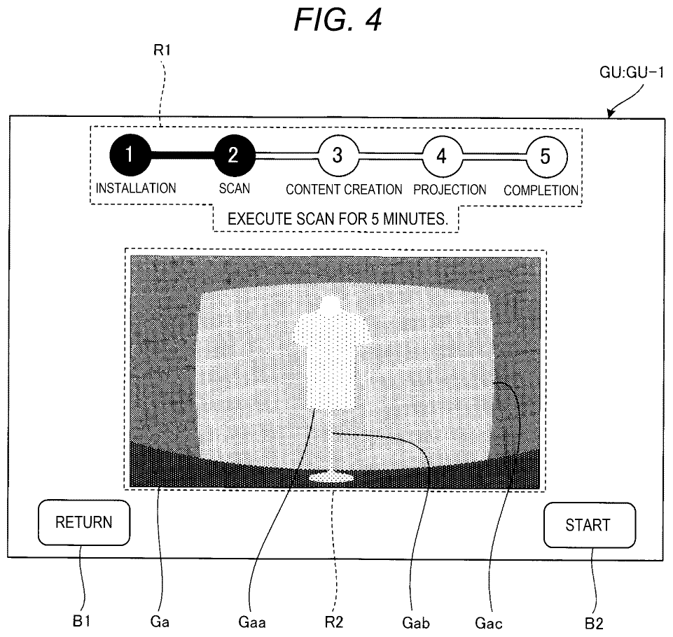

The above is the flow of the content editing method. Examples of the user interface image GU used for the content editing method are explained below with reference to FIGS. 4 to 8. In FIGS. 4 to 8, user interface images GU-1 to GU-5 are illustrated as the user interface image GU that transitions according to a progress status of content editing. In the following explanation, the user interface images GU-1 to GU-5 are sometimes referred to as user interface images GU without being distinguished from one another. The user interface image GU is not limited to the examples illustrated in FIGS. 4 to 8.

FIG. 4 is a diagram illustrating a display example for receiving acquisition of the captured image Ga. FIG. 4 illustrates the user interface image GU-1 displayed on the display device 34 after the execution of step S2 and before the execution of step S3 explained above. The user interface image GU-1 includes regions R1 and R2 and buttons B1 and B2.

In the region R1, a progress status of content editing is displayed. In the example illustrated in FIG. 4, items of “installation”, “scan”, “content creation”, “projection”, and “completion” are displayed in the region R1. An execution target or an executed item and an unexecuted item are displayed in a distinguishable manner.

Here, the items of “installation”, “scan”, “content creation”, “projection”, and “completion” are executed in this order. The item of “installation” is an indication indicating that guidance concerning installation of the camera 10 and the projector 20 is performed. The item of “scan” is an indication indicating that shape measurement for a projection target object is performed. The item “content creation” is an indication indicating that the content image is edited. The item of “projection” is an indication indicating that projection by the projector 20 is performed. The item of “completion” is an indication indicating that the content editing has been completed.

The region R1 of the user interface image GU-1 indicates that “scan” is the execution target. In the region R1, characters “Execute scan for 5 minutes” indicating that the start of “scan” is prompted are displayed. When the execution target shifts from “installation” to “scan”, the camera 10 is capable of capturing an image of the projection target object. When the execution target shifts from “installation” to “scan”, the acquirer 32a acquires the captured image data DGa by controlling the operation of the camera 10 in step S3 explained above.

Although not illustrated, when “installation” is the execution target, the display controller 32b causes the display device 34 to display the user interface image GU including an image for, for example, guiding the installation of the projector 20 to irradiate the projection target object with the light of the projector 20 or guiding the installation of the camera 10 to be able to capture an image of the projection target object. When “installation” is the execution target, a button for executing the start of the content editing is displayed on the user interface image GU. When the user operates the button for executing the start of the content editing, the execution target shifts to “scan”.

In the region R2, a necessary image is displayed according to the progress status of the content editing. In the region R2 of the user interface image GU-1, the captured image Ga indicated by the captured image data DGa is displayed. The captured image Ga includes an image Gaa indicating the object OJa, an image Gab indicating the object OJb, and an image Gac indicating the object OJc. Accordingly, the user can visually recognize, in the region R2, the projection target object included in the image capturing region RC of the camera 10. For example, if an image captured when an image entirely having a single color is projected from the projector 20 is used as the captured image Ga, the user can visually recognize, in the region R2, that the projection target object is present in each of the image capturing region RC of the camera 10 and the projection region RP of the projector 20. An image projected in this case may not be the image having the single color. By using the image having the single color such as white, the captured image Ga can be simplified.

The button B1 is an indication for receiving return of the item of the execution target to the preceding item. In the example illustrated in FIG. 4, when operation on the button B1 is performed, the item of the execution target changes to “installation”.

The button B2 is an indication for receiving start of processing of the item of the execution target. In the example illustrated in FIG. 4, when operation on the button B2 is performed, “scan”, which is the execution target, is started.

When the execution of “scan” is started, the measurer 32e controls the operation of the projector 20 to sequentially project a plurality of measurement patterns onto the projection target object and controls the operation of the camera 10 to capture images of the measurement patterns projected onto the projection target object. Accordingly, a plurality of captured images obtained by capturing images of the measurement patterns with the camera 10 are obtained. The measurer 32e measures a projection surface, which is the surface of the projection target object, based on the plurality of captured images. The measurement of the projection surface refers to generation of a transformation matrix for performing projective transformation between a coordinate system of a captured image of the camera 10 and a coordinate system of the display device of the projector 20. The measurer 32e generates the transformation matrix by associating, based on the plurality of captured images, a coordinate of a measurement pattern in the coordinate system of the captured image of the camera 10 and a coordinate of the measurement pattern in the coordinate system of the display device of the projector 20.

As the measurement pattern, for example, a binary code pattern is used. The binary code pattern refers to an image for expressing a coordinate of the display device using a binary code. The binary code is a technique of expressing, with on and off of a switch, values of digits in the case in which any numerical value is expressed in binary. When a binary code pattern is used as a measurement pattern, an image projected by the projector 20 corresponds to the switch. Pattern images equivalent to a number of digits of a binary number representing a coordinate value are required. Separate measurement patterns are required respectively for a coordinate in the longitudinal direction and a coordinate in the lateral direction. For example, when the resolution of the display panel of the projector 20 is 120×90, since each of 120 and 90 is expressed by a binary number of seven digits, seven images are required to express the coordinate in the longitudinal direction and seven images are required to express the coordinate in the lateral direction.

When the binary code pattern is used as the measurement pattern, in general, the robustness of measurement is reduced by the influence of ambient light such as illumination. For this reason, when the binary code pattern is used as the measurement pattern, it is preferable to concurrently use a complementary pattern from the viewpoint of suppressing the influence of ambient light and improving the robustness of measurement. The complementary pattern is an image in which black and white are inverted.

The measurement pattern is not limited to the binary code pattern and may be other structured light such as a dot pattern, a rectangular pattern, a polygonal pattern, a checker pattern, a gray code pattern, a phase shift pattern, or a random dot pattern.

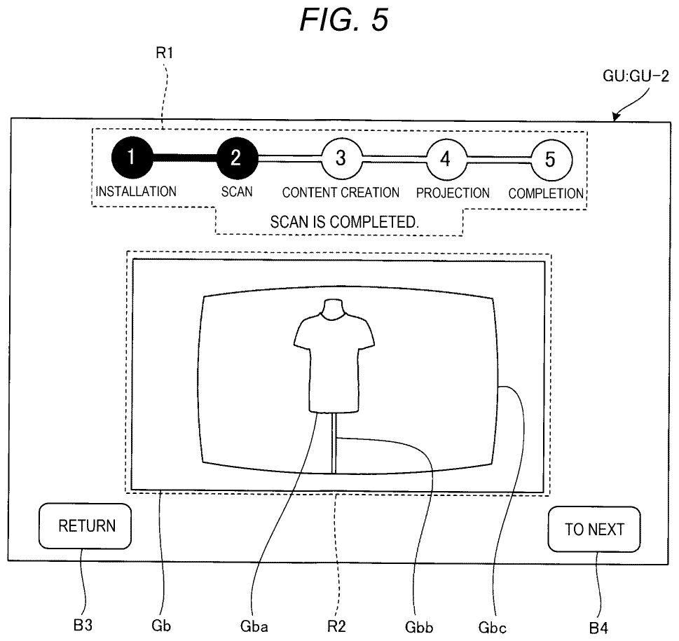

FIG. 5 is a diagram illustrating a display example of a first line drawing. FIG. 5 illustrates the user interface image GU-2 displayed on the display device 34 after execution of step S4 and before execution of step S5 explained above. The user interface image GU-2 includes buttons B3 and B4 instead of the buttons B1 and B2 of the user interface image GU-1.

The region R1 of the user interface image GU-2 indicates that “scan” is the execution target. In the region R1, characters “Scan is completed” indicating that “scan” has been completed are displayed. The transformation data DGf is obtained according to the completion of “scan”. Thereafter, in step S4, the image editor 32c generates the line drawing data DGb based on the captured image data DGa.

The line drawing Gb indicated by the line drawing data DGb is displayed in the region R2 of the user interface image GU-2. The line drawing Gb includes an image Gba indicating the object OJa, an image Gbb indicating the object OJb, and an image Gbc indicating the object OJc. Accordingly, the visibility of the contour of the projection target object can be improved. Here, each of the images Gba, Gbb, and Gbc is represented as a closed region segmented by the line of the line drawing Gb. The image Gba is an example of a “first image”.

As explained above, in step S4 explained above, the program PR explained above causes the computer to display, based on the captured image Ga obtained by capturing an image of the object OJa, the image Gba in which the contour of the object OJa is indicated by a line.

The button B3 is an indication for receiving return to a state before the execution of “scan”. The button B4 is an indication for receiving advance of an execution target item to the next item. In the example illustrated in FIG. 5, when operation on the button B4 is performed, the execution target shifts to “content creation”.

FIG. 6 is a diagram illustrating a display example of the editing image Gd. FIG. 6 illustrates the user interface image GU-3 displayed on the display device 34 during the execution of step S8 explained above. User interface image GU-3 includes buttons B5 and B6 instead of the buttons B3 and B4 of the user interface image GU-2 and includes a region R3.

In the region R3, an image Gcg including a plurality of content images indicated by the content image data DGc is displayed. Each of the plurality of content images is capable of receiving selection. FIG. 6 exemplifies an aspect in which four content images are arranged in a matrix and illustrates a state in which a lower left content image among the four content images is selected. The number of content images displayed in the region R3 is not limited to the example illustrated in FIG. 6 and is optional and may be three or less or five or more or may be one.

The region R1 of the user interface image GU-3 indicates that “content creation” is the execution target. In the region R1, characters “Please tap and select a shape to be cut” indicating that designation of a cut shape of a content image is prompted after selection of the content image are displayed. Although not illustrated, in the region R1, before the display for prompting the designation of the cut shape of the content image, display for prompting the selection of the content image is performed in step S5.

In the region R2 of the user interface image GU-3, the editing image Gd indicated by the editing image data DGd is displayed. The editing image Gd is an image in which the line drawing Gb indicated by the line drawing data DGb and the content image Gc indicated by the content image data DGc are superimposed. In the example illustrated in FIG. 6, the content image Gc indicated by the content image data DGc is superimposed over the entire line drawing Gb indicated by the line drawing data DGb. The editing image Gd is generated in step S6 explained above and thereafter displayed in step S7 explained above. Although not illustrated, in the region R1 before the selection of the content image during the execution of step S5, only the line drawing Gb indicated by the line drawing data DGb may be displayed or any content image Gc may be superimposed on the line drawing Gb.

As explained above, in step S7 explained above, the program PR explained above causes the computer to execute displaying the editing image Gd in which the content image Gc indicating the content is superimposed on at least a part of the image Gba. In the present embodiment, the content image Gc is displayed in the entire region R2. However, the position, the shape, and the size of the content image Gc are not limited to this. For example, in an initial state, the content image Gc smaller than the region R2 may be displayed or the content image Gc and the image Gba may not partially or entirely overlap.

Here, in step S8 explained above, the editing image Gd is capable of receiving selection of a closed region segmented by the line of the line drawing Gb. When this selection is performed (step S8: YES), the shape of the selected closed region is designated as a cut shape and the step S9 explained above is executed. In the example illustrated in FIG. 6, a desired closed region is selected by being tapped by a cursor CUR. FIG. 6 exemplifies a case in which a closed region corresponding to the image Gba indicating the object OJa is selected. A closed region other than the image Gba, for example, a region equivalent to a background can also be selected by tapping. In this case, the image representing the selected closed region is equivalent to the “first image” and an object corresponding to the selected closed region is the projection target object.

As explained above, in step S8 explained above, the program PR explained above causes the computer to execute receiving input for changing at least one of the position, the shape, and the size of the content image Gc in the editing image Gd. For example, the position of the content image Gc is changed by selecting the closed region. The cut shape is designated, whereby the shape and the size of the content image Gc are changed. Depending on the position, the shape, and the size of the content image Gc before the selection, it is also possible that any of the position, the shape, and the size does not change as a result of the selection. Here, the input in step S8 explained above includes input for selecting the image Gba.

In addition, when the selection is performed or when the cursor CUR is superimposed on the closed region segmented by the line of the line drawing Gb to focus the closed region, the region is highlighted. In the example illustrated in FIG. 6, the cursor CUR is superimposed on a closed region corresponding to the image Gba indicating the object OJa. The highlighting is performed by thickening a line indicating the contour of the image Gba. A method of the highlighting is not limited to the example illustrated in FIG. 6 and may be, for example, a method of differentiating the contour, the entire color, the brightness, or the like of the region of the image Gba from those of other regions.

As explained above, during the execution of step S8 explained above, the program PR explained above causes the computer to execute highlighting the image Gba when the image Gba is selected or the image Gba is focused.

In the region R2, tabs Gs1 and Gs2 for receiving operation of switching a display mode are displayed. When operation on the tab Gs1 is performed, as a first display mode, the editing image Gd is displayed in the region R2 as explained above. On the other hand, when operation on the tab Gs2 is performed, as a second display mode, the captured image Ga is displayed in the region R2 as explained below instead of the editing image Gd or in addition to the editing image Gd. The tabs Gs1 and Gs2 are a type of buttons for receiving the switching operation and are not limited to a so-called tab shape.

As explained above, in step S8 explained above, the program PR explained above causes the computer to execute displaying the user interface image GU for selecting one of the first display mode and the second display mode and displaying the editing image Gd when the first display mode is selected.

The button B5 is an indication for receiving return of the execution target item to “scan”, which is the item before “edit content”. The button B6 is an indication for receiving advance of the execution target item to the next item. In the example illustrated in FIG. 6, when operation on the button B6 is performed, the execution target shifts to “projection”. When operation on the button B6 is performed when no closed region is selected, the processing in steps S9 to S11 may be omitted and the processing may be shifted to step S13 to shift the execution target to “projection” or characters or the like for notifying that a shape to be cut is not designated may be displayed without the execution target being shifted.

FIG. 7 is a diagram illustrating a display example of the first display mode of the edited content image Gc. FIG. 7 illustrates the user interface image GU-4 displayed on the display device 34 during the execution of steps S10 and S11 explained above. The user interface image GU-4 is the same as the user interface image GU-3 explained above except that the shape of the content image Gc of the editing image Gd displayed in the region R2 is different and the shape of the content image Gc can be adjusted. FIG. 7 illustrates the first display mode, which is a display mode in the case in which operation on the tab Gsl explained above is performed.

As explained above, even during the execution of steps S10 and S11 explained above, the program PR explained above causes the computer to execute displaying the editing image Gd when the first display mode is selected.

The region R1 of the user interface image GU-4 indicates that “content creation” is the execution target. In the region R1, characters “You can adjust the shape of content” indicating that the shape of a content image can be adjusted are displayed.

The editing image Gd is displayed in the region R2 of the user interface image GU-4. Here, the shape of the content image Gc of the editing image Gd is trimmed to match the shape of the image Gba in step S9 explained above. The content image Gc is displayed in the trimmed shape in the region R2 of the user interface image GU-4. The content image Gc having the trimmed shape may be displayed by editing the content image data DGc to cut an unnecessary portion of the content image Gc or may be displayed by, without editing the content image data DGc, displaying a mask image that hides the unnecessary portion of the content image Gc.

As explained above, in step S9 explained above, the program PR explained above causes the computer to execute displaying the content image Gc in a state in which the content image Gc is changed based on the input in step S8 explained above. Specifically, when the input for selecting the image Gba is received in step S8 explained above, the program PR explained above causes the computer to execute displaying the content image Gc in a shape close to the shape of the image Gba superimposed on the image Gba.

Here, the content image Gc is capable of receiving adjustment of a contour shape. In the example illustrated in FIG. 7, a plurality of dots are arranged along the contour of the content image Gc. The contour shape of the content image Gc is adjusted by selecting any one dot from the plurality of dots and thereafter moving the selected dot using the cursor CUR. An indication for adjusting the contour shape of the content image Gc is not limited to the example using the dots illustrated in FIG. 7 and may be any indication capable of receiving operation of selecting and moving a part or the entire contour. In the user interface image GU-4, a different content image Gc may be selected by receiving operation on the region R3. In this case, the content image Gc selected anew may be trimmed according to the shape of the content image Gc at the time when the operation on the region R3 is performed and then displayed in the region R2.

As explained above, in step S10 explained above as well, the program PR explained above causes the computer to execute receiving input for changing at least one of the position, the shape, and the size of the content image Gc in the editing image Gd.

The input in step S10 explained above includes input for deforming the contour of the content image Gc. When the input in step S10 is received, the program PR explained above causes the computer to execute displaying the content image Gc superimposed on the image Gba with the contour of the content image Gc deformed.

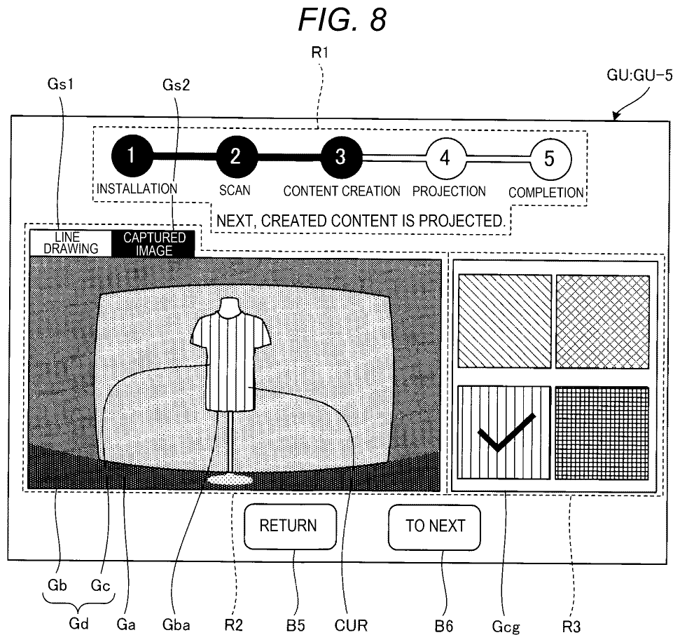

FIG. 8 is a diagram illustrating a display example in the second display mode of the edited content image Gc. FIG. 8 illustrates the user interface image GU-5 displayed on the display device 34 during the execution of steps S10 and S11 explained above. The user interface image GU-5 is the same as the user interface image GU-4 explained above except that the captured image Ga is displayed in the region R2. FIG. 8 illustrates a second display mode, which is a display mode in the case in which operation on the tab Gs2 explained above is performed.

The region R1 of the user interface image GU-5 indicates that “content creation” is the execution target. In the region R1, characters “Next, project created content” indicating that the content image can be projected are displayed.

In the region R2 of the user interface image GU-5, the captured image Ga is displayed superimposed on the editing image Gd. Here, in the region R2 of the user interface image GU-5, the content image Gc is displayed in a trimmed shape. As explained above, by displaying the trimmed content image Gc superimposed on the captured image Ga, it is possible to more visually provide, through display of the display device 34, an image close to an actual projection state of the content image Gc.

As explained above, when the second display mode is selected during the execution of steps S10 and S11 explained above, the program PR explained above causes the computer to execute displaying the content image Gc superimposed on at least a part of the captured image Ga.

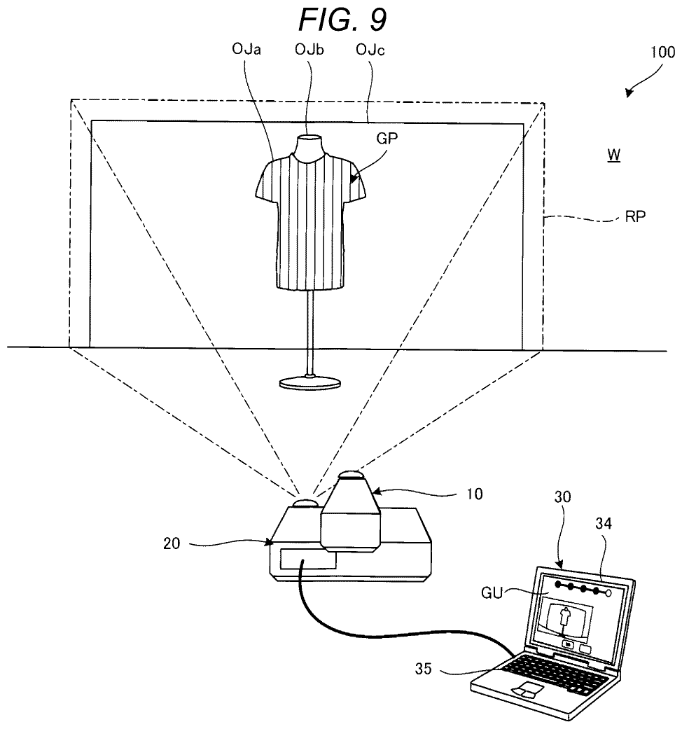

FIG. 9 is a diagram illustrating projection using the edited content image Gc. In step S13 explained above, as illustrated in FIG. 9, the edited content image Gc is projected onto the object OJa by the projector 20.

As explained above, the content editing method includes displaying, based on the captured image Ga obtained by capturing an image of the object OJa, the image Gba in which the contour of the object OJa is indicated by a line, displaying the editing image Gd in which the content image Gc indicating the content is superimposed on at least a part of the image Gba, receiving input for changing at least one of the position, the shape, and the size of the content image Gc in the editing image Gd, and displaying the content image Gc in a state in which the content image Gc is changed based on the input for changing.

As explained above, the information processing device 30 includes the input device 35, the display device 34, and the processing device 32. Then, the processing device 32 executes causing the display device 34 to display, based on the captured image Ga obtained by capturing an image of the object OJa, the image Gba in which the contour of the object OJa is indicated by a line. The processing device 32 executes causing the display device 34 to display the editing image Gd in which the content image Gc indicating the content is superimposed on at least a part of the image Gba. Further, the processing device 32 executes receiving, via the input device 35, input for changing at least one of the position, the shape, and the size of the content image Gc in the editing image Gd. The processing device 32 executes causing the display device 34 to display the content image Gc in a state in which the content image Gc is changed based on the input for changing.

In the content editing method explained above, in the information processing device 30 or the program PR, since the image Gba in which the contour of the object OJa is indicated by a line is displayed, it is easy for the user to visually recognize the contour of the object OJa, which is the projection target object, indicated by the image Gba. Since the editing image Gd in which the content image Gc is superimposed on at least a part of the image Gba is displayed, it is easy for the user to visually recognize a relation of the position, the shape, and the size of the content image Gc with respect to the image Gba. Moreover, since the input for changing at least one of the position, the shape, and the size of the content image Gc in the editing image Gd is received, at least one of the position, the shape, and the size of the content image Gc can be adjusted with high accuracy to match the contour of the object OJa. As a result, it is easy to edit content. It is possible to set a projection image to a position and a size intended by the user.

In the present embodiment, as explained above, the input for changing includes input for selecting the image Gba. When receiving the input for selecting the image Gba, the program PR further causes the computer to execute displaying the content image Gc superimposed on the image Gba in a shape close to the shape of the image Gba. For this reason, with simple operation of performing the input for selecting the image Gba, it is possible to designate the object OJa projected and display the content image Gc in a shape corresponding to the shape of the object OJa. By displaying the content image Gc superimposed on the image Gba in the shape close to the shape of the image Gba, it is easy for the user to visually recognize a relation of the position, the shape, and the size of the content image Gc with respect to the image Gba.

As explained above, the input for changing includes input for deforming the contour of the content image Gc. When receiving the input for deforming, the program PR further causes the computer to execute displaying the content image Gc superimposed on the image Gba in a state in which the contour of the content image Gc is deformed. For this reason, the content image Gc can be edited according to the user's intention.

Further, as explained above, the program PR further causes the computer to execute displaying the user interface image GU for selecting one of the first display mode and the second display mode, displaying the editing image Gd when the first display mode is selected, and displaying the content image Gc superimposed on at least a part of the captured image Ga when the second display mode is selected. For this reason, it is possible to select, according to the user's intention, a state in which the content image Gc is displayed superimposed on at least a part of the image Gba and a state in which the content image Gc is displayed superimposed on at least a part of the captured image Ga.

As explained above, when the image Gba is selected or the image Gba is focused, the program PR further causes the computer to execute highlighting the image Gba. For this reason, it is possible to improve the visibility of the contour of the object OJa, which is the projection target object, indicated by the image Gba according to the user's intention.

### 2. SECOND EMBODIMENT

A second embodiment of the present disclosure is explained below. In the embodiment exemplified below, the reference numerals and signs used in the explanation in the first embodiment are used for elements having the same action and functions as those in the first embodiment, and detailed explanation of the elements is omitted as appropriate.

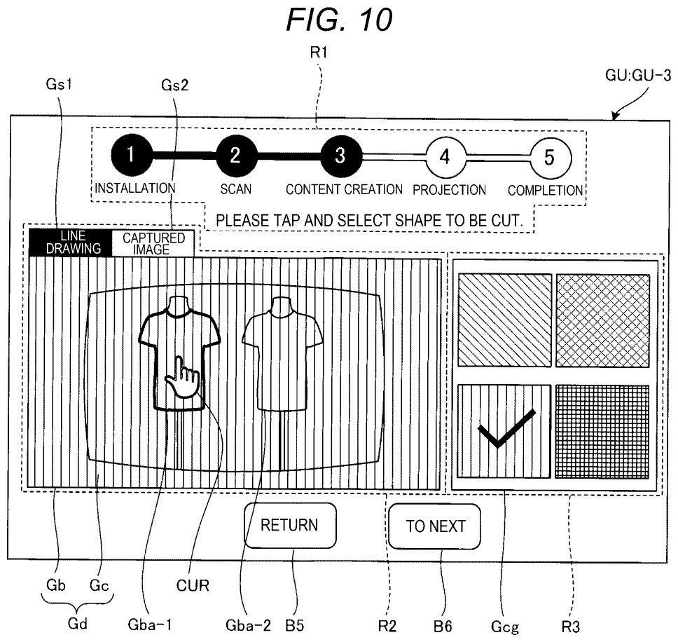

FIG. 10 is a diagram illustrating a display example of the editing image Gd in the second embodiment. FIG. 10 illustrates the user interface image GU-3 displayed on the display device 34 during the execution of step S8 explained above. The present embodiment is the same as the first embodiment explained above except that there are two objects OJa that can be projection target objects. Therefore, in the present embodiment, images of the two objects OJa are captured in the captured image Ga. Here, one object OJa of the two objects OJa is an example of a “first object”, and the other object OJa is an example of a “second object”.

In the present embodiment, as illustrated in FIG. 10, the line drawing Gb includes an image Gba-2 indicating the object OJa equivalent to the second object besides an image Gba-1 indicating the object OJa equivalent to the first object. The image Gba-1 is an example of a “first image” and the image Gba-2 is an example of a “second image”. As explained above, displaying the image Gba-1 includes displaying, besides the image Gba-1, the image Gba-2 in which the contour of the object OJa equivalent to the second object is indicated by a line.

Here, each of the image Gba-1 and the image Gba-2 is capable of receiving operation such as designation of a cut shape like the image Gba in the first embodiment explained above. As explained above, the input in step S8 in the present embodiment includes input for selecting the image Gba-1 or the image Gba-2. In the example illustrated in FIG. 10, the cursor CUR is superimposed on a closed region corresponding to the image Gba-1. The highlighting is performed by thickening the line indicating the contour of the image Gba-1.

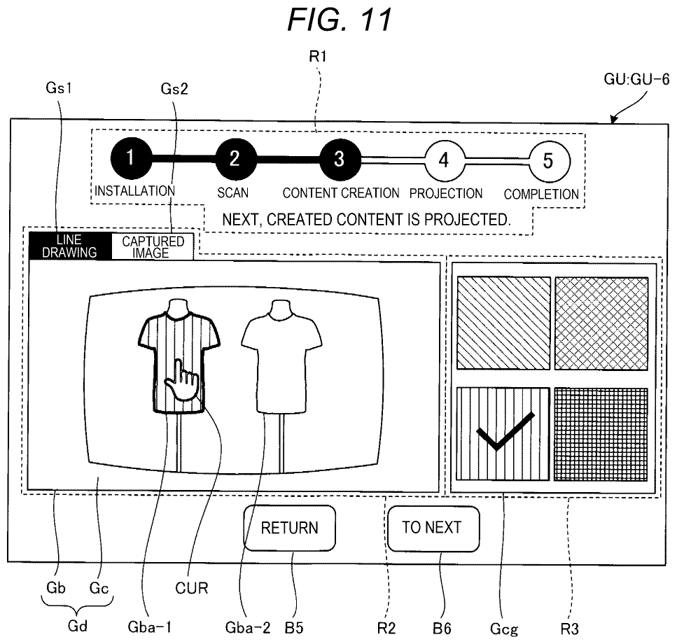

FIG. 11 is a diagram illustrating a display example of the edited content image Gc in the case in which the image Gba-1 is selected. FIG. 11 illustrates the user interface image GU-6 displayed on the display device 34 during the execution of steps S10 and S11 explained above.

In the present embodiment, as illustrated in FIG. 11, when receiving the input for selecting the image Gba-1, the program PR causes the computer to display the content image Gc superimposed on the image Gba-1 in a shape close to the shape of the image Gba-1.

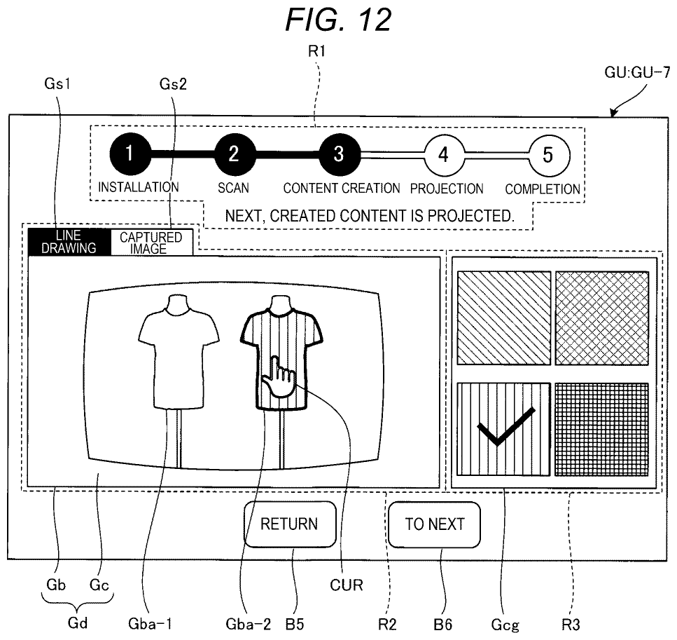

FIG. 12 is a diagram illustrating a display example of the edited content image Gc in the case in which the image Gba-2 is selected. FIG. 12 illustrates the user interface image GU-7 displayed on the display device 34 during the execution of steps S10 and S11 explained above.

In the present embodiment, as illustrated in FIG. 12, when receiving the input for selecting the image Gba-2, the program PR causes the computer to display the content image Gc superimposed on the image Gba-2 in a shape close to the shape of the image Gba-2.

According to the second embodiment explained above as well, it is possible to facilitate editing of content. In the present embodiment, as explained above, since the input for selecting the image Gba-1 or the image Gba-2 is possible, even when there are a plurality of objects that can be the projection target, it is possible to edit the content image Gc after selecting an object to be a projection target according to the user's intention.

### 3. MODIFICATIONS

The embodiments exemplified above can be variously modified. Specific aspects of modifications applicable to the embodiments explained above are exemplified below. Two or more aspects optionally selected from the following exemplification can be combined as appropriate in a range in which the aspects do not contradict one another.

### 3-1. Modification 1

In the embodiments explained above, the aspect in which the first image is the line drawing is exemplified. However, this aspect is not limiting and the first image may be in an aspect in which the contour of the first object is more easily seen compared with the captured image.

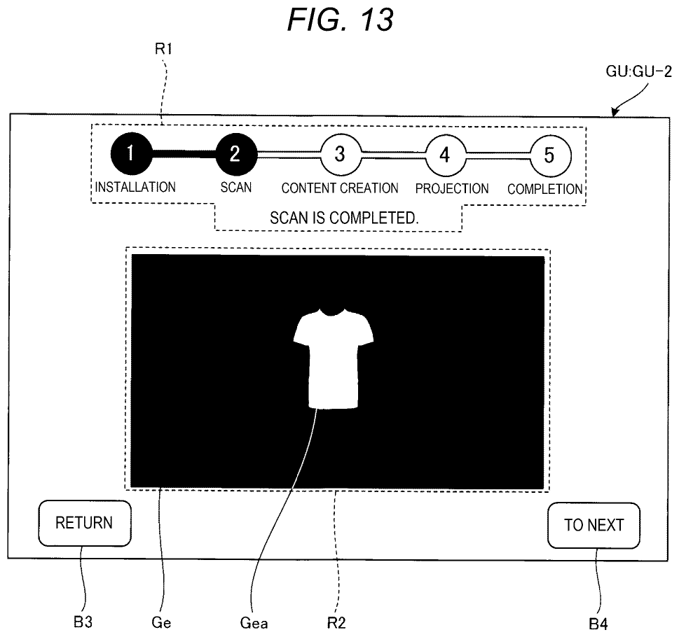

FIG. 13 is a diagram illustrating another display example of the first image. FIG. 13 illustrates the user interface image GU-2 displayed on the display device 34 after the execution of step S4 and before the execution of step S5 explained above. The user interface image GU-2 illustrated in FIG. 13 is the same as the user interface image GU-2 in the first embodiment except that the image Ge is displayed in the region R2 instead of the line drawing Gb. The image Ge is an example of the “first image”. In FIG. 13, for convenience of description, images corresponding to the objects OJb and OJc in the image Ge are not displayed.

The image Ge includes an image Gea representing the object OJa. Here, in the image Gea, the contour of the object OJa is indicated by differentiating colors of the inside and the outside of the contour. That is, by painting the inner side and the outer side of the contour of the object OJa shown in the image Gea in different colors, the contour is illustrated without using a thick line. With such an image Gea as well, the visibility of the contour of the object OJa, which is the projection target object, can be improved. In FIG. 13, for convenience of drawing, an aspect in which the inside of the contour of the object OJa is displayed in white and the outside of the contour is displayed in black is exemplified. However, the colors of the inner and outer sides of the contour of the object OJa are not particularly limited and are optional if the colors are different from each other. The image Ge may be displayed superimposed on the line drawing Gb explained above. The number of colors and closed regions is not limited to two. For example, an image indicating the object OJb may be displayed using a third color.

### 3-2. Modification 2

In the embodiments explained above, the aspect in which the number of objects OJa that can be the projection target object is one or two is exemplified. However, this aspect is not limiting and the number may be three or more.

### 3-3. Modification 3

In the embodiments explained above, the aspect in which one closed region is selected as the first image is exemplified. However, this aspect is not limiting and two or more closed regions may be selected. For example, in the second embodiment, the image Gba-1 and the image Gba-2 may be selected.

### 4. APPENDIXES

A summary of the present disclosure is appended below.

(Appendix 1) A recording medium recording a program, the program causing a computer to execute displaying, based on a captured image obtained by capturing an image of a first object, a first image in which a contour of the first object is indicated by a line, displaying an editing image in which a content image indicating content is superimposed on at least a part of the first image, receiving input for changing at least one of a position, a shape, and a size of the content image in the editing image, and changing at least one of the position, the shape, and the size of the content image based on the input for changing.

In the aspect of the appendix 1 explained above, since the first image in which the contour of the first object is indicated by the line is displayed, it is easy for a user to visually recognize the contour of the first object, which is a projection target object indicated by the first image. Since the editing image in which the content image is superimposed on at least a part of the first image is displayed, it is easy for the user to visually recognize a relation of the position, the shape, and the size of the content image with respect to the first image. Moreover, since input for changing at least one of the position, the shape, and the size of the content image in the editing image is received, it is possible to accurately adjust at least one of the position, the shape, and the size of the content image to match the contour of the first object. As a result, it is easy to edit content. It is possible to set a projection image to a position and a size intended by the user.

(Appendix 2) The recording medium recording the program according to the appendix 1, wherein the input for changing includes input for selecting the first image, and the changing includes displaying the content image superimposed on the first image in a shape close to a shape of the first image when the input for selecting the first image is received.

In the aspect of the appendix 2 explained above, it is possible to, with simple operation of performing the input for selecting the first image, designate an object to be projected and display the content image in a shape corresponding to the shape of the object. Since the content image is displayed superimposed on the first image in the shape close to the shape of the first image, it is easy for the user to visually recognize the relation of the position, the shape, and the size of the content image with respect to the first image.

(Appendix 3) The recording medium recording the program according to the appendix 1 or the appendix 2, wherein in the captured image, images of the first object and a second object are captured, the displaying the first image includes displaying the first image and a second image indicating a contour of the second object with a line, the input for changing includes input for selecting the first image or the second image, and the changing includes displaying the content image superimposed on the first image in a shape close to a shape of the first image when the input for selecting the first image is received and displaying the content image superimposed on the second image in a shape close to a shape of the second image when the input for selecting the second image is received.

In the aspect of the appendix 3 explained above, even when there are a plurality of objects that can be a projection target, it is possible to edit the content image after selecting an object to be the projection target according to the user's intention.

(Appendix 4) The recording medium recording the program according to any one of the appendixes 1 to 3, wherein the input for changing includes input for deforming a contour of the content image, and the changing includes deforming the contour of the content image when the input for deforming is received, and displaying the content image, the contour of which is deformed, superimposed on the first image.

In the aspect of the appendix 4 explained above, it is possible to edit the content image according to the user's intention.

(Appendix 5) The recording medium recording the program according to any one of the appendixes 1 to 4, the program further causing the computer to execute displaying a user interface image for selecting one of a first display mode and a second display mode displaying the editing image when the first display mode is selected; and displaying the content image superimposed on at least a part of the captured image when the second display mode is selected.

In the aspect of the appendix 5 explained above, it is possible to select, according to the user's intention, a state in which the content image is displayed superimposed on at least a part of the first image and a state in which the content image is displayed superimposed on at least a part of the captured image.

(Appendix 6) The recording medium recording the program according to any one of the appendixes 1 to 5, the program further causing the computer to execute, when the first image is selected or when the first image is focused, highlighting the first image.

In the aspect of the appendix 6 explained above, it is possible to improve the visibility of the contour of the first object, which is the projection target object indicated by the first image, according to the user's intention.

(Appendix 7) A recording medium recording a program, the program causing a computer to execute displaying, based on a captured image obtained by capturing an image of a first object, a first image in which a contour of the first object is indicated by differentiating colors of an inside and an outside of the contour from each other, displaying an editing image in which a content image indicating content is superimposed on at least a part of the first image, receiving input for changing at least one of a position, a shape, and a size of the content image in the editing image, and changing at least one of the position, the shape, and the size of the content image based on the input for changing.

In the aspect of the appendix 7 explained above, since the first image in which the contour is indicated by differentiating the colors of the inside and the outside of the contour of the first object from each other is displayed, it is easy for a user to visually recognize the contour of the first object, which is a projection target object indicated by the first image. Since the editing image in which the content image is superimposed on at least a part of the first image is displayed, it is easy for the user to visually recognize a relation of the position, the shape, and the size of the content image with respect to the first image. Moreover, since input for changing at least one of the position, the shape, and the size of the content image in the editing image is received, it is possible to accurately adjust at least one of the position, the shape, and the size of the content image to match the contour of the first object. As a result, it is easy to edit content. It is possible to set a projection image to a position and a size intended by the user.

(Appendix 8) A content editing method comprising displaying, based on a captured image obtained by capturing an image of a first object, a first image in which a contour of the first object is indicated by a line, displaying an editing image in which a content image indicating content is superimposed on at least a part of the first image, receiving input for changing at least one of a position, a shape, and a size of the content image in the editing image, and displaying at least one of the position, the shape, and the size of the content image in a state in which at least one of the position, the shape, and the size of the content image is changed based on the input for changing.

In the aspect of the appendix 8 explained above, since the first image in which the contour of the first object is indicated by the line is displayed, it is easy for a user to visually recognize the contour of the first object, which is a projection target object indicated by the first image. Since the editing image in which the content image is superimposed on at least a part of the first image is displayed, it is easy for the user to visually recognize a relation of the position, the shape, and the size of the content image with respect to the first image. Moreover, since input for changing at least one of the position, the shape, and the size of the content image in the editing image is received, it is possible to accurately adjust at least one of the position, the shape, and the size of the content image to match the contour of the first object. As a result, it is easy to edit content. It is possible to set a projection image to a position and a size intended by the user.

(Appendix 9) An information processing device comprising input device, a display device, and a processing device programmed to execute, causing the display device to display, based on a captured image obtained by capturing an image of a first object, a first image in which a contour of the first object is indicated by a line, causing the display device to display an editing image in which a content image indicating content is superimposed on at least a part of the first image, receiving, via the input device, input for changing at least one of a position, a shape, and a size of the content image in the editing image, and changing at least one of the position, the shape, and the size of the content image based on the input for changing.

In the aspect of the appendix 9 explained above, since the first image in which the contour of the first object is indicated by the line is displayed, it is easy for a user to visually recognize the contour of the first object, which is a projection target object indicated by the first image. Since the editing image in which the content image is superimposed on at least a part of the first image is displayed, it is easy for the user to visually recognize a relation of the position, the shape, and the size of the content image with respect to the first image. Moreover, since input for changing at least one of the position, the shape, and the size of the content image in the editing image is received, it is possible to accurately adjust at least one of the position, the shape, and the size of the content image to match the contour of the first object. As a result, it is easy to edit content. It is possible to set a projection image to a position and a size intended by the user.

What is claimed is:

1. A recording medium recording a program, the program causing a computer to execute:
displaying, based on a captured image obtained by capturing an image of a first object, a first image in which a contour of the first object is indicated by a line;
displaying an editing image in which a content image indicating content is superimposed on at least a part of the first image;
receiving input for changing at least one of a position, a shape, and a size of the content image in the editing image; and
changing the at least one of the position, the shape, and the size of the content image based on the input for changing.

2. The recording medium recording the program according to claim 1, wherein
the input for changing includes input for selecting the first image, and
the changing includes displaying the content image superimposed on the first image in a shape close to a shape of the first image when the input for selecting the first image is received.

3. The recording medium recording the program according to claim 1, wherein
the captured image includes images of the first object and a second object,
the displaying the first image includes displaying the first image and a second image indicating a contour of the second object with a line,
the input for changing includes input for selecting the first image or the second image, and
the changing includes
displaying the content image superimposed on the first image in a shape close to a shape of the first image when the input for selecting the first image is received; and
displaying the content image superimposed on the second image in a shape close to a shape of the second image when the input for selecting the second image is received.

4. The recording medium recording the program according to claim 1, wherein
the input for changing includes input for deforming a contour of the content image, and
the changing includes:
deforming the contour of the content image when the input for deforming is received; and
displaying the content image having the contour deformed by the defrorming and superimposed on the first image.

5. The recording medium recording the program according to claim 1, the program further causing the computer to execute:
displaying a user interface image for selecting one of a first display mode and a second display mode;
displaying the editing image when the first display mode is selected; and
displaying the content image superimposed on at least a part of the captured image when the second display mode is selected.

6. The recording medium recording the program according to claim 1, the program further causing the computer to execute, when the first image is selected or when the first image is focused, highlighting the first image.

7. A content editing method comprising:
displaying, based on a captured image obtained by capturing an image of a first object, a first image in which a contour of the first object is indicated by a line;
displaying an editing image in which a content image indicating content is superimposed on at least a part of the first image;
receiving input for changing at least one of a position, a shape, and a size of the content image in the editing image; and
displaying at least one of the position, the shape, and the size of the content image in a state in which at least one of the position, the shape, and the size of the content image is changed based on the input for changing.

8. An information processing device comprising:
an input device;
a display device; and
a processing device programmed to execute:
displaying, by the display device, based on a captured image obtained by capturing an image of a first object, a first image in which a contour of the first object is indicated by differentiating colors of an inside and an outside of the contour from each other;
displaying, by the display device, an editing image in which a content image indicating content is superimposed on at least a part of the first image;
receiving, via the input device, input for changing at least one of a position, a shape, and a size of the content image in the editing image; and
changing the at least one of the position, the shape, and the size of the content image based on the input for changing.
